(19) United States
(12) Patent Application Publication
(10) Pub. No.: US 2019/0196441 A1
(43) Pub. Date: Jun. 27, 2019

(54) APPARATUS, METHOD, AND COMPUTER READABLE MEDIA FOR CONTROLLING MACHINING PARAMETERS

(71) Applicants: Fu Tai Hua Precision Electronics (Zhengzhou)Co., Ltd., Zhengzhou (CN); Cloud Network Technology Singapore Pte. Ltd., Singapore (SG)

(72) Inventors: CHENG-I SUN, New Taipei (TW); CHUN-YU LIU, New Taipei (TW); WEN-BIN LU, New Taipei (TW); CHIA-YEN LI, New Taipei (TW); XIAO-DONG WANG, Zhengzhou (CN)

(21) Appl. No.: 15/876,206

(22) Filed: Jan. 22, 2018

(30) Foreign Application Priority Data
Dec. 27, 2017 (CN) 201711446000.4

(51) Int. Cl. G05B 19/404; G05B 11/42; G05B 13/04

(52) U.S. Cl. CPC G05B 19/404; G05B 2219/49181; G05B 13/042; G05B 11/42

(57) ABSTRACT

A method for controlling and adjusting a machining parameter of a processing machine detects and acquires information of workpieces during processing, and calculates an error compensation depending on the detected information and a mathematical model. The error compensation is compared with a first preset value and a determination made as to whether the error compensation is greater than a first preset value. The machining parameter is adjusted when the error compensation is not greater than the first preset value, the processing machine can be stopped if greater. An apparatus, and a non-transitory computer readable medium for controlling the machining parameter are also disclosed.

### CROSS-REFERENCE TO RELATED APPLICATIONS

This application claims priority to Chinese Patent Application No. 201711446000.4 filed on Dec. 27, 2017, the contents of which are incorporated by reference herein.

### FIELD

The disclosure generally relates to control technology, and to an apparatus, method, and computer readable media for controlling machining, and particularly to an apparatus, method, and computer readable media for controlling machining parameters of a plurality of processing machines.

### BACKGROUND

There is a need to adjust processing parameters of a processing machine in a process. Such processing parameters are conventionally adjusted manually.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a functional block diagram of an exemplary embodiment of an apparatus for controlling machining parameters.

FIG. 2 is a functional block diagram of an exemplary embodiment of a system for controlling machining parameters.

FIG. 3 is a flow diagram of an exemplary embodiment of a method for controlling machining parameters.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures, and components have not been described in detail so as not to obscure the related relevant feature being described. Further, the description is not to be considered as limiting the scope of the embodiments described herein. The drawings are not necessarily to scale and the proportions of certain parts may be exaggerated to better illustrate details and features of the present disclosure.

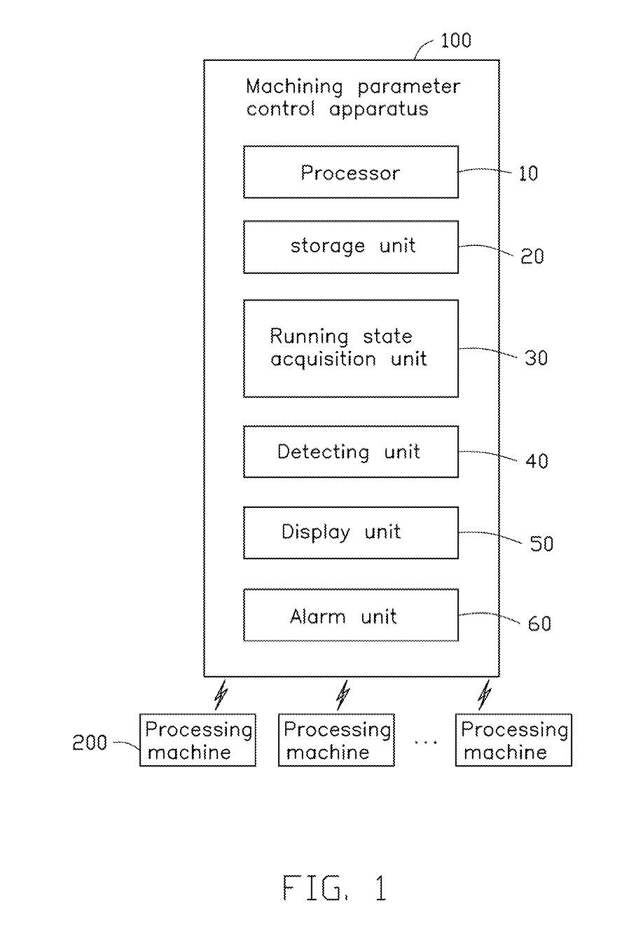

FIG. 1 shows an machining parameters controlling apparatus 100 in accordance with an exemplary embodiment. The apparatus 100 can be used for controlling the machining parameters of a plurality of processing machines 200. The apparatus 100 can communicate with each of the plurality of processing machines 200. The processing machines 200 can be a computer numerical control (CNC) machine, a milling machine, or other machines. The processing machines 200 can be same or different.

The apparatus 100 includes a processor 10, a storage unit 20, a running state acquisition unit 30, a detecting unit 40, a display unit 50, and an alarm unit 60. The storage unit 20, the running state acquisition unit 30, the detecting unit 40, the display unit 50, and the alarm unit 60 are electrically coupled to the processor 10.

The processor 10 can be a central processing unit, a digital signal processor, or a single chip, for example.

The storage unit 20 can be used to store data output by the running state acquisition unit 30, the detecting unit 40, the display unit 50, and the alarm unit 60. The storage unit 20 can be further used to store standard values of the machining parameters, a number of first preset values of error compensation and a tolerance range thereof, and a number of second preset values of error compensation. The first preset value of error compensation for one machining parameter is greater than the second preset value of error compensation. If the error compensation is less than the second preset value of error compensation, the machining parameter can be automatically adjusted.

In at least one embodiment, the storage unit 20 can be an internal storage system, such as a flash memory, a random access memory (RAM) for temporary storage of information, and/or a read-memory (ROM) for permanent storage of information.

In at least one embodiment, the storage unit 20 can also be a storage system, such as a hard disk, a storage card, or a data storage medium. The storage unit 20 can include volatile and/or non-volatile storage devices.

In at least one embodiment, the storage unit 20 can include two or more storage devices such that one storage device is a memory and the other storage device is a hard drive. Additionally, the storage unit 20 can be located either entirely or partially external relative to the apparatus 100.

The running state acquisition unit 30 can be used to acquire a running state of each of the processing machines 200. The running state acquisition unit 30 can be a monitoring device mounted above a processing machine 200. In other embodiments, the running state acquisition unit 30 can be a detecting device mounted in the processing machine 200.

The detecting unit 40 can be used to measure and detect workpieces being processed by the processing machines 200, to detect and acquire information of the workpieces. The detecting information can include length, width, height, flatness value, or other data. The detecting unit 40 can be a measuring device, a flatness detecting device, or other detecting devices. The detecting unit 40 can be mounted in each of the processing machines 200. In other embodiments, the detecting unit 40 can be an independent and separate device.

The display unit 50 can be used to display the detected information of the workpieces, the running state of the processing machines 200, results of analysis of the error compensation, the calculated error compensation of the machining parameters, interfaces for controlling the machining parameters, and interfaces for controlling the running state of the processing machine and other controls.

The alarm unit 60 can be used to send an alert when the error compensation is greater than the first preset value. The alarm unit 60 can be further used to send an alarm for confirming the error compensation when the error compensation is greater than the second preset value but less than the first preset value. In at least one embodiment, the alarm unit 60 can be but is not limited to being visible warning device, voice warning device, or the like.

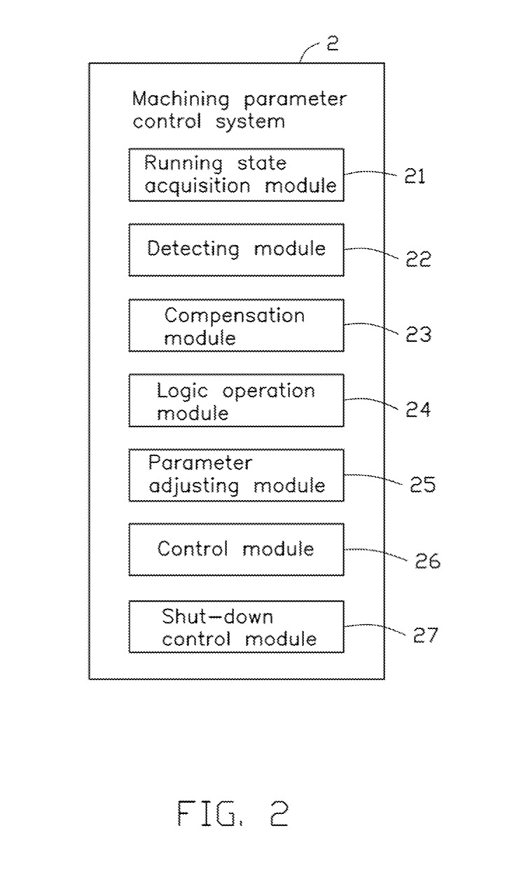

FIG. 2 shows a machining parameter control system 2. The machining parameter control system 2 can include a plurality of modules. The plurality of modules can include a running state acquisition module 21, a detecting module 22, a compensation calculating module 23, a logic operation module 24, a parameter adjusting module 25, a control module 26, and a shut-down module 27. The running state acquisition module 21, the detecting module 22, the compensation calculating module 23, the logic operation module 24, the parameter adjusting module 25, the control module 26, and the shut-down module 27 can be stored in the storage unit 20 of the machining parameter control apparatus 100, and further applied on the processor 10 of the machining parameter control apparatus 100. The modules of the machining parameter control system 2 can include separated functionalities represented by hardware or integrated circuits, or as software and hardware combinations, such as a special-purpose processor or a general-purpose processor with special-purpose firmware.

The running state acquisition module 21 is configured for acquiring the running states of the processing machines 200.

The detecting module 22 is configured for detecting and acquiring information of the workpieces processed by the processing machines 200.

The compensation calculating module 23 is configured for calculating the error compensation depending on the detected information of the workpieces and a mathematical model.

The logic operation module 24 is configured for comparing the error compensation with the first preset value. The logic operation module 24 is further configured for comparing the error compensation with the second preset value. If the error compensation is greater than the second preset value, the parameter cannot be automatically adjusted. If the error compensation is not greater than the second preset value, the parameter can be automatically adjusted. The second preset value can be set as demanded. For example, the second preset value can be 0.01.

The parameter adjusting module 25 is configured for receiving the error compensation, and automatically adjusting the machining parameters accordingly.

The control module 26 is configured for controlling the alarm unit 60 to send the alert when the error compensation is greater than the first preset value. The control module 26 is further configured for controlling the display unit 50 to display the error compensation, and controlling the alarm unit 60 to send the alarm for confirming the error compensation displayed on the display unit 50, when the error compensation is greater than the second preset value but less than the first preset value.

The shut-down module 27 is configured for stopping the processing machine 200. The shut-down module 27 can receive a signal from the logic operation module 24, and transmit a code to the processing machine 200, thus the processing machine 200 can execute the code and shut-down at a specific moment. After exceptions are handled, the shut-down module 27 can be further configured for unlocking and restarting the processing machine 200.

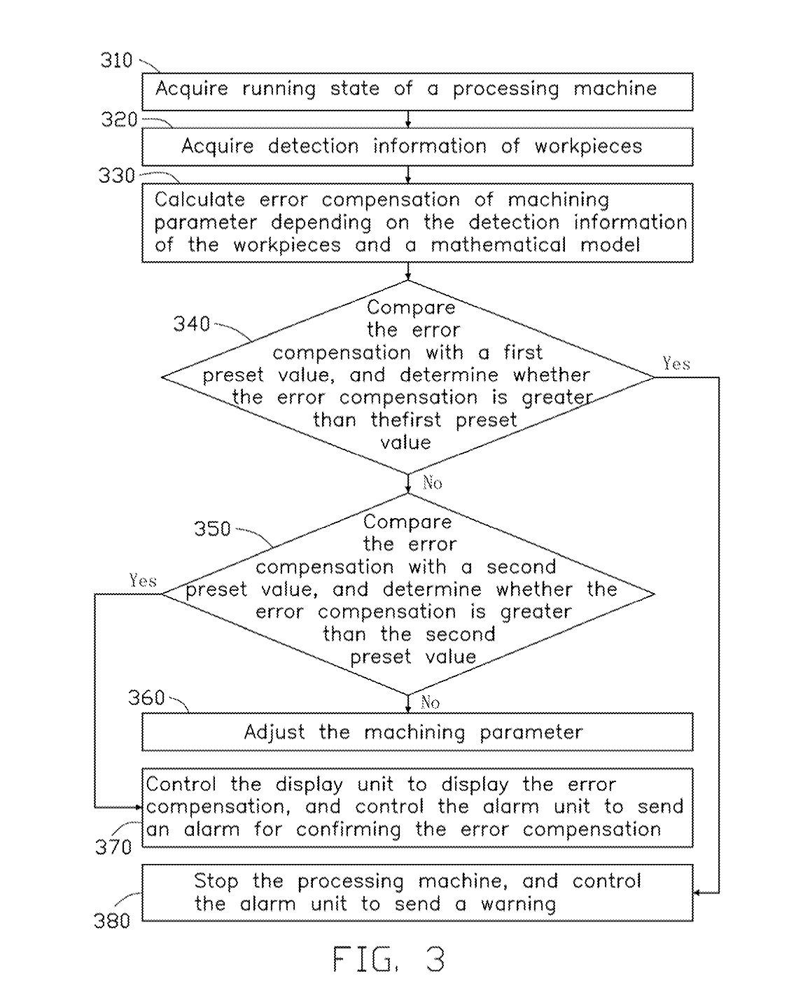

Referring to FIG. 3, a flow diagram of an exemplary embodiment of a method for controlling the processing parameter is shown, the notification method can begin at step 310.

In step 310, the running state acquisition module 21 acquires the running state of the processing machine 200.

In step 320, the detecting module 22 detects and acquires information of the workpieces acquired by the detecting unit 40.

In step 330, the compensation module 23 calculates the error compensation of the machining parameter depending on the detected information of the workpieces and the mathematical model.

In step 340, the logic operation module 24 compares the error compensation with a first preset value, and determines whether the error compensation is greater than the first preset value. If yes, the process goes to step 380, otherwise, the process goes to step 350.

In step 350, the logic operation module 24 compares the error compensation with a second preset value, and determines whether the error compensation is greater than the second preset value. If yes, the process goes to step 370, otherwise, the process goes to step 360.

In step 360, the parameter adjusting module 25 receives the error compensation, and automatically adjusts the machining parameter of the processing machine 200.

In step 370, the control module 27 controls the display unit 50 to display the error compensation, and controls the alarm unit 60 to send an alarm to an operator for confirming the error compensation.

In step 380, the shut-down module 27 controls the processing machine 200 to stop processing, and the control module 27 controls the alarm unit 60 to send an alert.

In other embodiments, the display unit 50 can be omitted.

In other embodiments, step 310 can be omitted, and the process begin at step 320.

The apparatus, method, and computer readable media for controlling machining parameters, are capable of calculating the error compensation of the machining parameters, and further adjusting the machining parameters automatically. Manual adjustment of the machining parameters is not required, thus the cost is saved, and the production efficiency is improved. The apparatus and method can detect the workpieces as they are being processed, and calculate the error compensation depending on the detected information and the mathematical model. The apparatus and method can in real time control and adjust the processing parameters. The apparatus, method, and computer readable media can control the machining parameters for a plurality of processing machines.

It is to be understood, however, that even through numerous characteristics and advantages of the present disclosure have been set fourth in the foregoing description, together with details of assembly and function, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. An apparatus for controlling a machining parameter of a processing machine, comprising:
a detecting unit, configured for detecting workpieces being processed by the processing machine;
an alarm unit;
a processor; and
a non-transitory computer readable medium coupled to the processor and storing instructions for execution by the processor, the instructions causing the processor to:
acquire detection information of the workpieces;
calculate an error compensation of the machining parameter depending on the detection information of the workpieces and a mathematical model;
compare the error compensation with a first preset value, and determine whether the error compensation is greater than the first preset value; and
adjust the machining parameter when the error compensation is not greater than the first preset value.

2. The apparatus as claimed in claim 1, wherein the instructions further causes the processor to:
control the processing machine to stop, and control the alarm unit to send an alert, when the error compensation is greater than the first preset value.

3. The apparatus as claimed in claim 1, wherein the apparatus further comprises a running state acquisition unit configured for acquiring a running state of the processing machine, the instructions further causing the processor to:
acquire the running state of the processing machine.

4. The apparatus as claimed in claim 1, wherein the instructions further causes the processor to:
compare the error compensation with a second preset value, and determine whether the error compensation is greater than the second preset value, when the error compensation is not greater than the first preset value.

5. The apparatus as claimed in claim 4, wherein the apparatus further comprises a display unit, the instructions further causes the processor to:
control the display unit to display the error compensation, and control the alarm unit to send an alarm for confirming the error compensation, when the error compensation is greater than the second preset value.

6. A method for controlling a machining parameter of a processing machine, comprising:
acquiring detection information of workpieces being processed by the processing machine;
calculating an error compensation of the machining parameter depending on the detection information of the workpieces and a mathematical model;
comparing the error compensation with a first preset value, and determine whether the error compensation is greater than the first preset value; and
adjusting the machining parameter when the error compensation is not greater than the first preset value.

7. The method as claimed in claim 6, wherein the method further comprises a step of controlling the processing machine to stop, and control an alarm unit to send an alert, when the error compensation is greater than the first preset value.

8. The method as claimed in claim 6, wherein the method further comprises a step of acquiring a running state of the processing machine before acquiring the detection information of workpieces.

9. The method as claimed in claim 6, wherein the method further comprises a step of comparing the error compensation with a second preset value, and determining whether the error compensation is greater than the second preset value, when the error compensation is not greater than the first preset value.

10. The method as claimed in claim 9, wherein the method further comprises a step of controlling the display unit to display the error compensation, and controlling an alarm unit to send an alarm for confirming the error compensation, when the error compensation is greater than the second preset value.

11. A non-transitory computer readable medium coupled to a processor and storing instructions for execution by the processor, the instructions causing the processor to:
acquire detection information of workpieces being processed by a processing machine;
calculate an error compensation of a machining parameter depending on the detection information of the workpieces and a mathematical model;
compare the error compensation with a first preset value, and determine whether the error compensation is greater than the first preset value; and
adjust the machining parameter when the error compensation is not greater than the first preset value.

12. The apparatus as claimed in claim 11, wherein the instructions further causes the processor to:
control the processing machine to stop, and control the alarm unit to send an alert, when the error compensation is greater than the first preset value.

13. The apparatus as claimed in claim 11, wherein the instructions further causes the processor to:
acquire a running state of the processing machine.

14. The apparatus as claimed in claim 11, wherein the instructions further causes the processor to:
compare the error compensation with a second preset value, and determine whether the error compensation is greater than the second preset value, when the error compensation is not greater than the first preset value.

15. The apparatus as claimed in claim 14, wherein the instructions further causes the processor to:
control a display unit to display the error compensation, and control an alarm unit to send an alarm for confirming the error compensation, when the error compensation is greater than the second preset value.
